(19) United States
(12) Patent Application Publication
(10) Pub. No.: US 2003/0191704 A1
(43) Pub. Date: Oct. 9, 2003

(54) Long-term cumulative return maximization strategy

(76) Inventor: Silviu Iulian Alb, New Orleans, LA (US)

Correspondence Address: Silviu Iulian Alb, Apt. E, 1028 S. Carrollton Ave., New Orleans, LA, 70118, US

(21) Appl. No.: 10/118,812

(22) Filed: Apr. 9, 2002

(51) Int. Cl. G06F 17/60

(52) U.S. Cl. 705/36

(57) ABSTRACT

A portfolio optimization method for maximizing long-term cumulative return is provided. The method consists in selecting the portfolio with the highest probability-weighted geometric mean of payoffs. It can be mathematically proven that maximizing the geometric mean is the investing strategy that, over the long term, will outperform any other strategy in terms of cumulative return.

### CROSS REFERENCE TO RELATED APPLICATIONS

### U.S. Patent Documents

| | | | |
|---|---|---|---|
| 6003018 | December 1999 | Michaud et al. | 705/36 |

### Other references

“The Relative Value Theory”, Silviu I. Alb, June 2001, http://netec.mcc.ac.uk/WoPEc/data/Papers/wpawuwpfi0106003.html “The Utility of Wealth”, Harry Markowitz, 1959, Journal of Political Economy 60 “Security prices, Risk, and Maximal Gains from Diversification”, John Lintner, 1965, Journal of Finance 20

### BACKGROUND OF THE INVENTION

The invention relates generally to the field of financial advisory services (U.S. Class 705/36). Investors appear to be primarily concerned with maximizing expected return, intended as the probability-weighted arithmetic mean of returns, for a given level of risk, usually defined in terms of variance of returns. According to the classical paradigm due to Markowitz, a so-called “mean-variance efficient” portfolio can be derived using mathematical algorithms known in the art. One deficiency of such portfolio optimization is the instability of solutions.

While the goal of maximizing the mean-variance ratio is popular among portfolio managers, and has received much attention in the art, little attention, if any, was given to the goal of maximizing long-term cumulative returns. The popularity of such goal is expected to significantly increase in the future.

### BRIEF SUMMARY OF THE INVENTION

The invention consists in optimizing a portfolio by maximizing the probability-weighted geometric mean of payoffs.

An investors expectations concerning the evolution of a set of available assets can be modeled using a set of scenarios, each having its own probability. Within any given scenario, the present value (payoff) of any portfolio can be computed by discounting the combined cash flows of the assets in the portfolio. The investor can further compute the probability-weighted geometric mean of payoffs for the portfolio across all scenarios. The optimization method claimed consists in selecting the portfolio with the highest probability-weighted geometric mean of payoffs.

An alternate embodiment of the invention consists in using portfolio market values (after a predetermined period of time) instead of portfolio present values. All other aspects of the optimization process remain unchanged.

The described optimization process leads to stable solutions and ensures the maximization of long-term cumulative returns.

### DETAILED DESCRIPTION OF THE INVENTION

Investors are confronted with the problem of selecting the optimal portfolio from a set of available assets. Given such set, an investor will use judgement and experience to define his expectations concerning the possible future evolutions of the set. The investor can describe such expectations using a large set of possible scenarios, each having an associated probability.

For any given scenario, the present value of any portfolio can be calculated by discounting the portfolio's stream of cash flows for the considered scenario, using a unique discount rate representing time value of money. We will refer to such present values as portfolio payoffs. Every scenario determines the payoff for any given portfolio.

The probability-weighted geometric mean of payoffs for the considered portfolio can be easily calculated:

$$M = {\prod }_{i = 1}^{S} {( {P}_{i} )}^{{p}_{i}} \qquad ( EQ \# 1 )$$

where,

S is the number of possible scenarios

i consecutively identifies each of the S scenarios

M is the probability-weighted geometric mean of payoffs

Pᵢ is the portfolio payoff corresponding to scenario i

pᵢ is the probability associated with scenario i

The portfolio optimization method claimed consists in selecting, among all portfolios available to the investor, the one with the highest probability-weighted geometric mean of payoffs. Finding such portfolio is a maximization problem that can be solved using mathematical and numerical techniques known to persons skilled in the art. Such techniques include without being limited to: randomly selecting portfolios and keeping the one with the highest mean; orderly scanning the portfolio space for the highest mean; moving from an initial portfolio along the gradient of the mean; or setting the partial derivatives of the mean equal to zero and solving the resulting equation. All such techniques are within the scope of the present invention.

In order to make the invention more readily understandable the following simple example is provided. A risk free asset R_{f} and a risky asset R are considered. Two scenarios are possible: S₁ with probability 0.6, and S₂ with probability 0.4. Under scenario S₁ the risky asset R will generate a stream of cash flows so that a present value (payoff) of $1.3 will be returned for every $1 invested. Under scenario S₂ the risky asset will return a present value (payoff) of $0.65 for every $1 invested. Obviously, in both scenarios the risk free asset R_{f} will return a present value (payoff) of $1 for every $1 invested. The total capital available to the investor is $10 so he could, for instance, invest $2 in the risky asset and $8 in the risk free asset. Under scenario S₁ the payoff of such portfolio would be $10.6 (equal to 1.3 times $2 plus 1 times $8). Similarly, under scenario S₂ the payoff of such portfolio would be $9.3 (equal to 0.65 times $2 plus 1 times $8). The probability-weighted geometric mean of payoffs for the considered portfolio would be approximately $10.06 ($10.6 raised to the power of 0.6, times $9.3 raised to the power of 0.4). Using mathematical and numerical techniques one can find that the optimal portfolio results from investing $3.80952381 in the risky asset, and the remaining $6.19047619 in the risk free asset.

The set of scenarios and associated probabilities used to model expectations can be construed by determining the possible payoffs for each individual asset (and related probabilities), assuming the assets are non-correlated, and deriving the set of scenarios by extracting all possible combinations of asset payoffs. For instance, when asset R₁ has two possible payoffs P1₁ and P1₂ (with probabilities p1₁ and p1₂), asset R₂ has two possible payoffs P2₁ and P2₂ (with probabilities p2₁ and p2₂), and R₁ and R₂ are non-correlated, expectations can be modeled by deriving four scenarios:

Under scenario 1, R₁'s payoff is P1₁, and R₂'s payoff is P2₁, the scenario's probability being p1₁ times p2₁;

Under scenario 2, R₁'s payoff is P1₁, and R₂'s payoff is P2₂, the scenario's probability being p1₁ times p2₂;

Under scenario 3, R₁'s payoff is P1₂, and R₂'s payoff is P2₁, the scenario's probability being p1₂ times p2₁;

Under scenario 4, R₁'s payoff is P1₂, and R₂'s payoff is P2₂, the scenario's probability being p1₂ times p2₂.

Such technique represents a particular case, not an alternative, of the general technique described above. Such particular case is mentioned because of its simplicity and likely future popularity.

In an alternative embodiment, investor expectations are modeled by a set of scenarios aimed at describing not present values of portfolio future cash flows but portfolio market values after a predetermined period of time. In such embodiment portfolio payoffs would represent portfolio market values, not portfolio present values. Other than the significance of payoffs the alternative embodiment is basically identical with the one previously described.

In an alternative embodiment, the disclosed methods for portfolio optimization may be implemented in whole or in part as a computer program product for use with a computer system. Such program may be distributed on any removable memory device, preloaded on a computer system, or distributed over a network (e.g., the Internet or World Wide Web). The invention may be implemented as entirely software, entirely hardware, or a combination of the two.

The described embodiments of the invention are intended to be merely exemplary and numerous variations and modifications will be apparent to those skilled in the art. All such variations and modifications are within the scope of the present invention.

I claim:

1. A portfolio optimization method that consists in selecting the portfolio with the highest probability-weighted geometric mean of payoffs, payoffs representing present values of the portfolio's future cash flows.

2. A portfolio optimization method that consists in selecting the portfolio with the highest probability-weighted geometric mean of payoffs, payoffs representing portfolio market values after a pre-determined period of time.

3. A computer program product for use on a computer system that implements either of the methods described in claim 1 or claim 2.
